(19) United States
(12) Patent Application Publication
(10) Pub. No.: US 2005/0188782 A1
(43) Pub. Date: Sep. 1, 2005

(54) Motor cycle foot pedal having concealed storage area

(76) Inventor: Savong Khiev, Fontana, CA (US)

Correspondence Address: Colin P. Abrahams;Suite 400, 5850 Canoga Avenue, Woodland Hills, CA, 91367, US

(21) Appl. No.: 11/114,387

(22) Filed: Apr. 26, 2005

Related U.S. Application Data
(63) Continuation of application No. 10/273,453, filed on Oct. 18, 2002, now abandoned.

(51) Int. Cl. B62H 1/00

(52) U.S. Cl. 74/560; 74/512; 280/291

(57) ABSTRACT

A foot peg for use on a motor cycle, the foot peg comprises a body portion having an outer surface of selected configuration, and having a storage compartment therein. The body portion has an access opening. A cover member is provided for covering the access opening to seal it from outside of the foot peg, and is movable between a closed position to close the access opening, and an open position to allow access to the storage compartment. A connector is formed on the body portion for connecting the foot peg to the motor cycle. The cover member is configured such that, when in the closed position, it is substantially continuous with the selected configuration of the outer surface of the body portion so as to substantially conceal from casual observation the existence of the storage compartment.

### CROSS REFERENCE TO RELATED APPLICATIONS

This application is a continuation application of U.S. patent application Ser. No. 10/273,453 filed Oct. 18, 2002, which is incorporated herein by reference in its entirety.

### FIELD AND BACKGROUND OF THE INVENTION

This invention relates to concealed storage areas or containers within the foot pedal, or foot peg, of a motor cycle.

Motor cycles are often very compact vehicles with a minimum of, or no, storage space for holding various items which a motor cycle rider may typically carry. Since many motor cycles are designed to comprise a frame which supports little more than various functional elements for the operation of the motor cycle, there is very little useful storage space available. In some instances, space may be provided under the seat or saddle, or in small covered containers thereunder, on each side of the frame. In many instances, these storage areas are well known and recognized, and easily visible, and can be simply observed by passers-by. In order to properly protect the contents of these storage areas, lock-up arrangements are often provided. These, in turn, require a key for accessing the storage spaces, making it more difficult to simply store and remove objects in a more convenient manner.

Additionally, motor cyclists often need to carry items such as spare keys, credit cards, money, licences cards, or other registration and insurance papers, some of which relate to the ownership and operation of the motor cycle. These are often difficult to store, owing to the absence of simple and accessible spaces for storage on a motor cycle. Conventional storage spaces on motor cycles, further, are frequently not designed for the storage of such items.

Based on the above, one aspect of the invention uses the foot peg or pedal of a motor cycle as a source of usable storage space for such items. Most, if not all, motor cycles accommodate a passenger, and foot pegs are provided on the frame of the motor cycle for the convenience and comfort of the passenger so that they will support the passenger's feet. In some instances, the foot peg or pedal may fold from a retracted position, in which the foot rest portion of the foot pedal bears up against the frame, and an extended position, wherein the foot rest extends outwardly from the frame of the motor cycle, and in which position it offers support for the passenger's feet.

Various patents in the literature show storage systems of different types. For example, U.S. Pat. No. 6,070,897 (Hsieh) describes a foot peg for a bicycle comprising a peg which is an add-on component fastened to the bicycle and comprises an interior with slots for holding hand tools, such as a screw driver and wrench. The foot peg contains the very tools which enable the foot peg itself to be maintained in a tight position on the bicycle.

U.S. Pat. No. 5,950,498 (Gossett) discloses a handle storage apparatus and method, which engages a handle bar. The storage apparatus is removable from inside the hollow tubing comprising the handle bar.

U.S. Pat. No. 3,167,284 (Lynch) describes a fishing rod carrier for a bicycle, which is connected to the hub of a wheel.

U.S. Pat. No. 4,676,120 (Borromeo), U.S. Pat. No. 5,862,965 (Nakahara), and U.S. Pat. No. 4,762,255 (Dunn) describe various other carriers and storage devices, typically linked to a bicycle.

### SUMMARY OF THE INVENTION

In one aspect, the invention comprises a foot pedal or peg, preferably for use by a passenger on a motor cycle, which has been adapted or modified so as to incorporate a hidden storage area which can be accessed by the rider, but which, in normal circumstances, resembles a regular non-storage type foot peg, and wherein the storage space remains concealed or hidden from general observation. Thus, the foot pedal of the invention is, for outward appearances, an apparent regular foot peg, but has been adapted so that a storage space is provided therein, and can be detected, at best, only upon closer observation.

The storage space within the adapted foot peg or pedal of the invention is intended to accommodate and conceal various smaller items which may typically be carried by a rider, such as money, credit cards, spare keys, official documentation and the like. Such materials can be accommodated within the storage area, and available for the user, but the storage space is concealed and hidden from general view so that its contents are substantially more secure.

The storage portion or chamber within the foot peg of the invention may close in various manners. In one form, a cover plate may be bolted or screwed to the remainder of the foot peg, the cover plate being constructed in such a manner that, when connected to the remainder of the foot peg, it is difficult from a casual observation to notice that a storage area is provided. Alternatively, a lock and key mechanism may be provided for securing a cover or closure piece to the remainder of the foot peg.

The foot peg of the invention may be of any convenient shape and size, but would typically emulate the size and shape of conventional foot pegs, so as not to attract any attention, and thereby alert passers-by that a storage space is present. In fact, the more conventional looking the foot peg is, with respect to existing type foot pegs, the more secure the contents of the foot peg storage area of the invention are likely to be, since the storage area would be more properly concealed and hidden from general view.

According to one aspect of the invention, there is provided a foot peg for use on a motor cycle, the foot peg comprising: a body portion having an outer surface of selected configuration, and having a storage compartment therein, the body portion having an access opening therein to provide access to the storage compartment through the outer surface; a cover member for covering the access opening and thereby sealing it from outside of the foot peg, the cover member being movable between a closed position to close the access opening, and an open position to allow access to the storage compartment; a connector portion formed on the body portion for connecting the foot peg to the motor cycle; securing means for securing the cover member to the body portion; the cover member being configured such that, when in the closed position, it is substantially continuous with the selected configuration of the outer surface of the body portion so as to substantially conceal from casual observation the existence of the storage compartment.

The body portion may be generally cylindrical in shape, or it may be of rectangular shape.

The cover member may comprise a contoured plate. The cover member may further comprise a projecting slab extending from the contoured plate, the projecting slab fitting within the access opening of the body portion, and the contoured plate covering the access opening.

The access opening is formed on an upper surface of the body portion, or the side surface of the body portion. The cover portion may comprise a screw-on cap. The securing means may comprise at least one bolt. Alternately, the securing means may comprise correspondingly threaded portions of the body portion and the cover member respectively or even a snap-on, mechanical connection.

Preferably, the cover member comprises a rectangular plate having long sides and short sides, and flange members extending from the plate, being continuous with the rectangular member, the flange portions engaging the body portion. In one form, flanges extend from both the long and the short edges of the cover plate.

Preferably, at least a part of the body portion has formed thereon a non-slip or non-skid surface. Further, the bolt may comprise a head having a hexagonal recess, and a key is provided for securing/fastening and unsecuring/unfastening the bolt.

### BRIEF DESCRIPTION OF THE DRAWINGS

FIG. 1 is a perspective view of a foot pedal with storage space of the invention, for securing to one side of a motor cycle frame;

FIG. 2 is a side view of the foot pedal with storage space as shown in FIG. 1 of the drawings, but for use on the other side of the frame of the motor cycle;

FIG. 3 is a perspective view of a foot pedal with storage space in accordance with the invention, showing another embodiment thereof;

FIG. 4 is a perspective view, schematically showing the storage space of the foot pedal and associated cover closure of the invention;

FIG. 5 is a perspective view of another embodiment of a foot pedal for a motor cycle with storage space; and

FIG. 6 is yet another embodiment of a foot pedal with storage space of the invention.

### DETAILED DESCRIPTION OF THE INVENTION

As illustrated in the drawings, the invention discloses a foot pedal, or extending peg, for use on a motor cycle, wherein the foot pedal comprises a storage area which will, under normal circumstances, be concealed or hidden from view by virtue of the construction of the foot pedal. The foot pedal of the invention is structured and designed so as to, from the external appearance thereof, emulate a conventional foot pedal, but includes mechanisms whereby a storage area or chamber is provided in the foot pedal, and access is provided to the storage area or chamber using mechanisms not initially obvious or easily detectable to the casual observer.

The foot pedal with storage space of the unit may come in many different shapes and sizes corresponding to those of existing foot pedals without storage spaces. The foot pedal with concealed storage space of the invention is intended to replace or substitute those conventional foot pedals, and be, in most respects, identical thereto, so that they will appear as foot pedals and nothing more, to the passing observer.

Each foot pedal contains a concealed storage space, the size of which is, of course, limited by the dimensions of the foot pedal itself. However, to the extent possible, the storage space may be designed to carry various items, such as a spare key, credit cards, money or other items and papers of importance, to give a few examples only.

Preferably, the storage space is carved out within the body of the foot pedal, and covered by a plate or cover piece which resembles a wall of the foot pedal. The cover piece may typically be bolted or screwed to the remainder of the foot pedal, although other mechanisms for attachment may be provided. Such mechanisms may include lock and key access, snap-on fastening, screw threaded caps and the like, some of which are described in the specification, and all of which are considered to form part of the invention.

Reference is now made to FIG. 1 of the drawings which shows one embodiment of a foot pedal with concealed storage space, in accordance with the invention. The foot pedal 10 comprises a body portion 12 and a connector 14. The connector 14 typically includes a square or other shaped aperture 16, through which a bolt or other connecting member may pass in order to connect the foot pedal 10 of the invention to the frame of a motor cycle. The connector 14 is shaped and configured in a manner so as to be properly integrated with the frame, so that its shape and design will vary depending upon the motor cycle to which it is being attached. Further, some foot pedals may pivot about an axis to enable the foot rest portion of the foot pedal to be extended when needed and retracted or stored when not needed.

The body portion 12 comprises an upper surface 18, an end wall 20, an inner wall 22, and a front wall 24. The body portion 12 has been hollowed out so as to provide a storage space 26, otherwise enclosed by the body portion 12, except for the opening 28 formed in the front wall 22 of the body portion 12. Thus, access to the storage space 26 is provided through the opening 28, and various items being carried by the rider may be inserted in the storage space 26, by pushing them through the opening 28.

A cover plate 30 is provided, the cover plate 30 being generally of rectangular shape, and corresponding in large part with the shape and size of the opening 28. The edges 32 about the opening 28 may be slightly recessed, so as to accommodate and receive the edges 34 of the cover plate 30. In any event, the cover plate 30 is intended to attach to the body portion 12 so as to cover and close off the opening 28 in such a manner that the existence of the cover plate 30 is most inconspicuous, and blends in generally with the shape and form of the body portion 12.

The cover plate 30 has a pair of apertures 36 and 38 which, when the cover plate 30 is over the access opening 28, corresponds with threaded bores 40 and 42 in the body portion 12. A bolt or screw 44 passes through aperture 36 into the threaded bore 40, while bolt 46 passes through aperture 38 into the threaded bore 42, and upon tightening of the bolts 44 and 46, the cover plate 30 is securely held to the remainder of the body portion 12.

The bolts 44 and 46, like the cover plate 30 itself, are preferably designed so as to be inconspicuous, and to convey the impression to the casual observer that the foot pedal 10 of the invention is conventional with a substantially solid form, so that the storage characteristics of the foot pedal 10 are hardly noticeable.

The upper surface 18 may have thereon a covering 48 so as to present a non-slip surface to the rider of the motor cycle, thereby providing better traction between the shoe and the foot pedal 10. Alternatively, instead of a covering 48, the upper surface 18 may be roughened or treated to provide a similar effect. This is a standard feature of foot pedals, and is consistent with the invention in providing a foot pedal with storage space that is concealed and hidden, so as to be unremarkable and not particularly noticeable to passers-by.

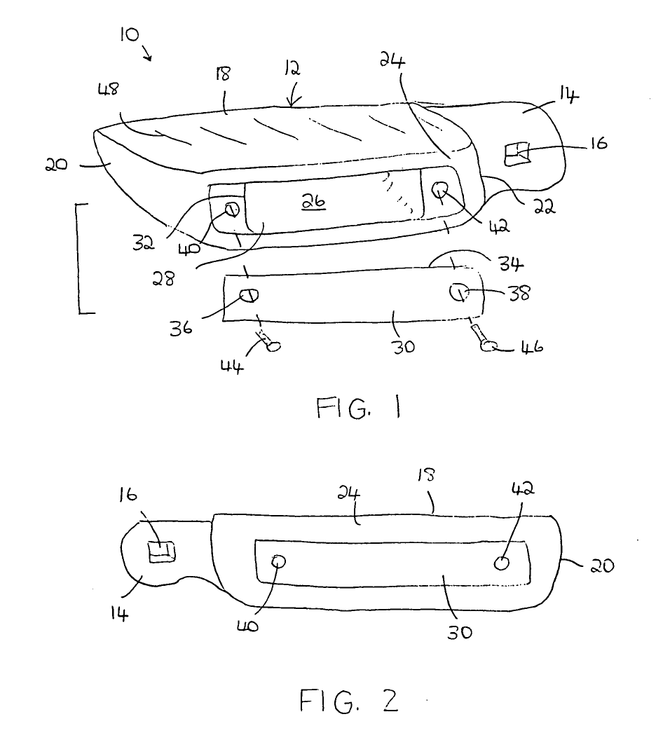

Reference is now made to FIG. 2 of the drawings, which shows a foot pedal 10 of the invention, in all respects identical to the foot pedal 10 in FIG. 1, but a mirror image thereof, and intended to be attached to the frame of the motor cycle on the opposite side thereof to that of the foot pedal 10 shown in FIG. 1 of the drawings. Otherwise, the various elements and components of the foot pedal 10 shown in FIG. 2 of the drawings are the same as in FIG. 1, and include a cover plate 30 secured in position so as to close off the storage space 26.

As will be observed with reference to FIGS. 1 and 2 of the drawings, the foot pedals shown therein show a storage space 26 which is accessed laterally, or from a vertical wall or through an opening in a vertical wall of the foot pedal.

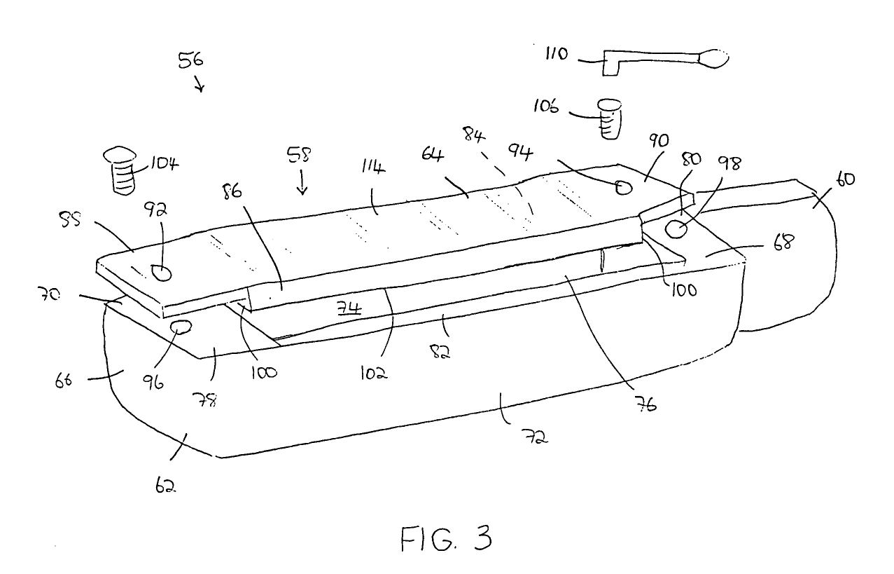

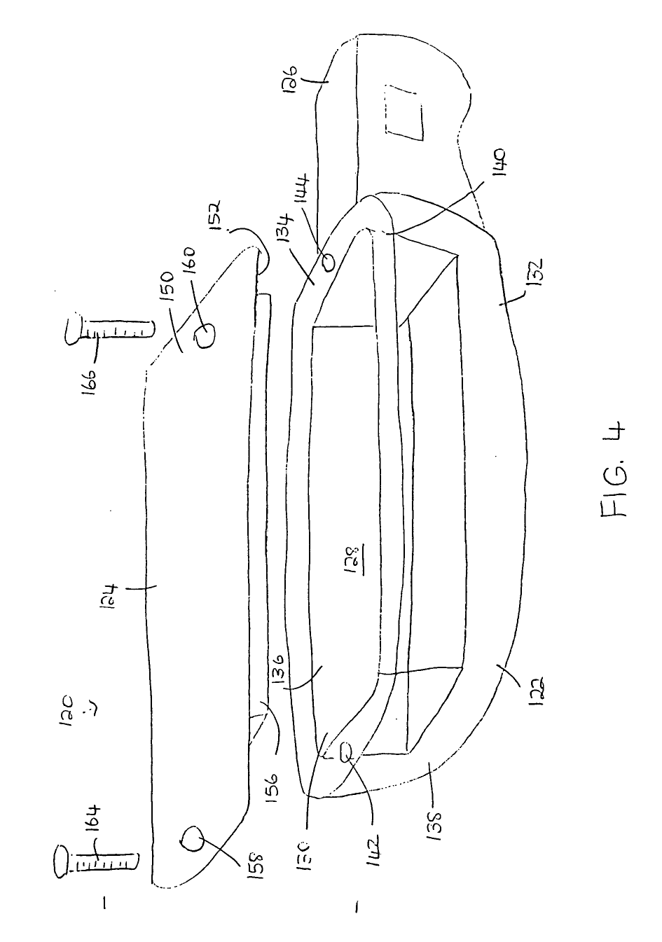

FIG. 3 of the drawings shows a foot pedal 56, which is another embodiment of the invention. The foot pedal 56 comprises a body portion 58 and a connector 60. As described with reference to FIG. 1, the connector 60 may be of appropriate size and shape according to the corresponding size and shape of the frame of the motor cycle to which it is to be attached. The connector 60 would be no different from any conventional foot pedal in terms of its size and shape, and ability to be attached to the motor cycle.

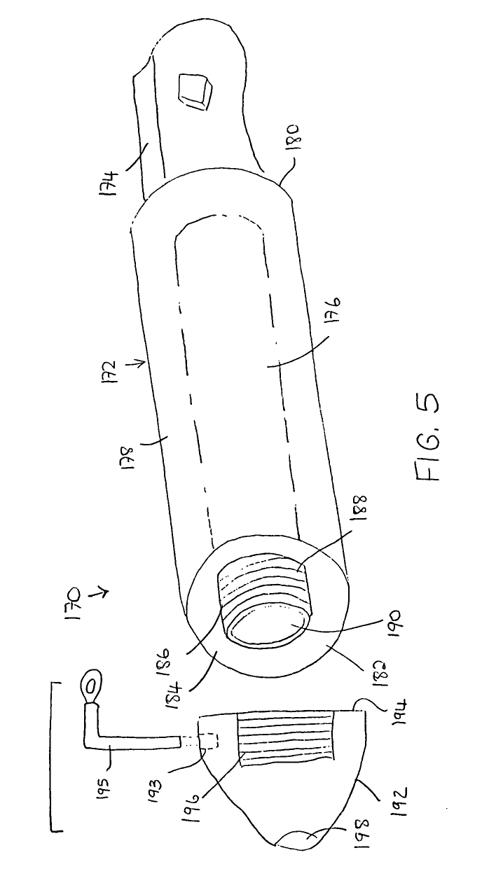

The body portion 58 comprises a housing 62 and a cover plate 64. The housing 64 has an outer wall 66, an inner wall 68, a front wall 70 and a rear wall 72. A storage space 74, comprising a chamber constructed into the body portion 58, occupies preferably as much of the body portion 58 as is possible, so as to maximize its size. The storage space 74 has an access opening 76 on the top, and the upper surface 58 of the housing 62 has a pair of opposing ledges 78 and 80. Between the ledges, the housing 62 has a front ledge 82, and a rear ledge 84 (as best seen in the similar embodiment shown in FIG. 4).

The foot pedal 56 further comprises the cover plate 64, an access closure piece 86 of generally rectangular shape, and a pair of opposing fastening flanges 88 and 90, integral therewith. The fastening flange 88, when the cover plate 64 is in the closed position, covers the ledge 78, while the fastening flange 90, when the cover plate 64 is in the closed position, covers the ledge 80. Each fastening flange 88 and 90 comprises an aperture 92 and 94 respectively, and there are corresponding threaded bores 96 and 98 formed in each of the ledges 78 and 80 respectively.

The foot pedal 56 is connected to the frame of a motor cycle by means of its connector 60, so that the ledges 78 and 80 are generally horizontal, and face upwardly. The cover plate 64 can be easily removed, and replaced onto, the housing 62 so as to seal off and enclose the storage space 74 in such a manner that its existence will not be apparent to casual observers. The cover plate 64 has an access closure piece 86 which is of slightly thicker dimension than each of the fastening flanges 88 and 90. A step 100 is thus formed at the point where the fastening flanges 88 and 90 respectively attach to the cover plate 64. When installing the cover plate 64 to close off the storage space 74, the steps 100 fit snugly within the access space and abut against the lateral walls respectively of the storage space 74. The lower surface 102 of the cover plate 64 rests upon the front ledge 82 and rear ledge 84 along a strip or perimeter portion thereof. In this position, aperture 92 registers with threaded bore 96, and aperture 94 registers with threaded bore 98. A bolt 104 passes through aperture 92 and engages threaded bore 96, while the bolt 106 passes through the aperture 94 and engages the threaded bore 98. The head of each of bolts 104 and 106 may have hexagonal or other shaped recesses therein (not shown), so that a hex key 110 can be used to easily securely fasten the cover plate 64 to the housing 62 by quickly tightening the bolts 104 and 106.

It will be seen that the embodiment of the foot pedal of the invention 56, as shown in FIG. 3 of the drawings provides a hidden compartment, accessible by means of loosening various bolts, and generally whose existence is not apparent to the passer-by. When the cover plate 64 rests on and is attached to the housing 62, the only evidence of the possible separateness of these two pieces may be the line of abutment between them, but this may only be visible from very close observation and careful scrutiny. The upper surface 114 of the cover plate 64 may also have a non-skid or non-slip surface, which further detracts from any joining point between the cover plate 64 and housing 62, and emphasizes the hidden and concealed nature of the storage space 74 to observers.

FIG. 4 of the drawings shows an embodiment somewhat similar to that shown in FIG. 3. However, the foot pedal 120 in FIG. 4 of the drawings is somewhat wider than that shown in FIG. 3 and, in addition, it has a more consistent, or non-stepped, upper ledge. The fitting of the cover plate, as will be described, is slightly different as well.

In FIG. 4, a foot pedal 120 comprises a housing 122 and a cover plate 124. The housing 122 has attached thereto a connector 126, which, as already described with respect to the previous embodiments, is designed and configured so as to attach to a particular motor cycle. The housing 122 defines a storage space or chamber 128, the storage space 128 including an access opening 130. The housing 122 has sides walls 132, 134, 136 and 138, each of the side walls having an upper surface so as to form a continuous, substantially rectangular ledge 140. Threaded bores 142 and 144 are formed on opposite sides of the rectangular ledge 140.

The cover plate 124 comprises a flat outer surface 150, the outer perimeter of which has a shape which corresponds to that defined by the rectangular ledge 140. On the lower surface 152 of the flat outer surface 150, there is formed a depending projecting portion 156, the depending projecting portion 156 having a perimeter with a shape which corresponds substantially with the access opening 130. The flat outer surface 150 has a pair of opposing apertures 158 and 160.

The storage space 128 can be accessed by removing the cover plate 124, and thereafter can be concealed and hidden by replacing the cover plate 124, as will be described.

As has already been mentioned, the outer perimeter of the flat outer surface 150 has a shape corresponding to the rectangular ledge 140, while the depending, projecting portion 156 has a perimeter shape which substantially corresponds to the shape of the access opening 130. Therefore, when the cover plate 124 is inserted over the housing 122, the depending projecting portion 156 will fit snugly within the access opening 130 so as to prevent any significant movement thereof. In this position, the flat outer surface 150 will cover completely the rectangular ledge 140. The cover plate 124 can be secured to the housing 122 using bolts 164 and 166. The bolt 164 passes through the aperture 158, and can be secured in the threaded bore 142. Likewise, the bolt 166 passes through the aperture 160, and can be secured in the threaded bore 144. The bolts are tightened either using the fingers, or a specially provided tool, so that the cover plate 124 is firmly secured to the housing 122. In such a position, owing to the relative shape and dimensions of the cover plate 124, the foot pedal 120 will, to a very substantial degree, resemble a solid, conventional foot pedal, thereby concealing and hiding the fact that the foot pedal 120 contains a storage space 128. In this way, various items can be stored within the storage space 128 in a secure manner without concern that they will be discovered and/or removed.

Reference is now made to FIG. 5 of the drawings, which shows yet another embodiment of a foot pedal in accordance with the present invention. The foot pedal 170 shown in FIG. 5 comprises a body portion 172, and a connector 174. As usual, the connector 174 is attached to the frame of a motor cycle, as already described. The body portion 122, integral with the connector 174, is of generally cylindrical shape and comprises a bored-out center which forms a storage chamber 176. The chamber 176, too, is of cylindrical shape. The body portion 172 comprises an outer wall 178, a closed end wall 180, and an open end 182. The open end 182 includes a flat annular surface 184, and a projecting threaded member 186, having outer threads 188. The threaded member 186 has an opening 190, which provides access to the storage chamber 176.

The body portion 172 is closed off by means of a cap 192 which, in the embodiment shown in FIG. 5 is of generally frusto-conical shape. The cap 192 includes annular surface 194, and a female threaded bore 196. The cap 192 tapers towards a narrow end 198. The cap 192 further includes a recessed hole 193, which in use receives a key 195, such as a hex key. The key 195 facilitates the opening and closing of the cap 192 by providing a lever to make this operation easier and more comfortable.

In use, material, a key, money or the like is inserted through the opening 190 and pushed into the storage chamber 176. Of course, the foot peg 170 itself, has already been attached to the frame of the motor cycle in a conventional manner by means of the connector 174. With the desired materials or items contained within the storage chamber 176, the cap 192 is fastened thereto, by securing the threaded bore 196 over the threaded member 186. The cap is tightened until such time as the annular surface 184 of the body portion 172 is flush with and abuts against the annular portion 194 of the cap 192. The cap 192 and body portion 172 are constructed so that the line of abutment therebetween is built to high tolerances, so that the line is very difficult to see unless scrutinized at close range.

FIG. 5 therefore shows a foot pedal 170 of different shape to that shown in the previous embodiments, and intended to replace conventional, cylindrical-shaped foot pedals, which may be conventionally affixed to the frame of a motor cycle for passenger use. The construction of the foot pedal 170 essentially conceals the existence of the storage space 176, providing a secure storage location for valuable and other items.

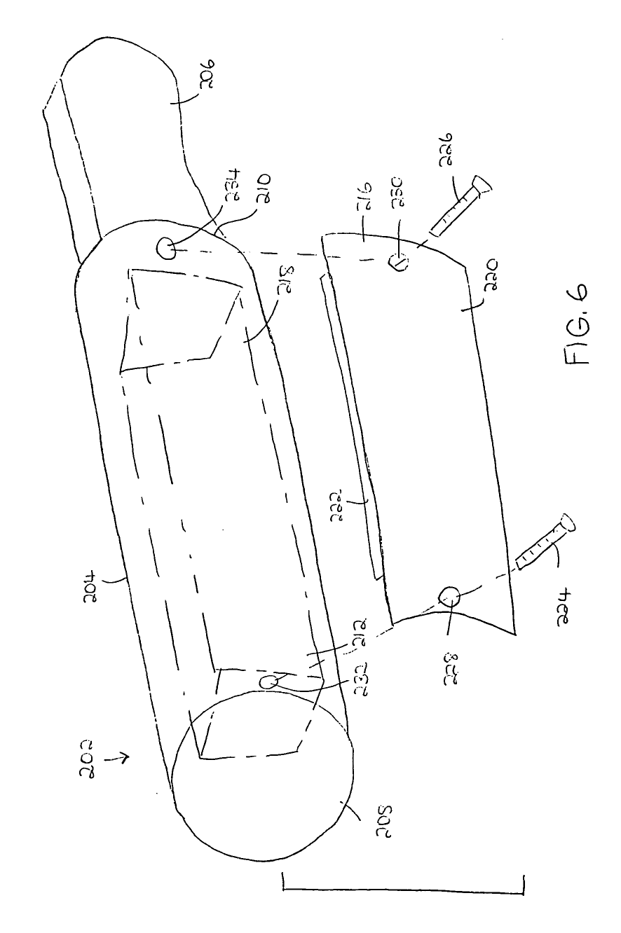

Reference is now made to FIG. 6 of the drawings which show yet a further embodiment of the invention. FIG. 6 shows a generally cylindrical-shaped foot pedal 202 comprising a body portion 204 and a connector 206. The connector is secured in conventional fashion. The body portion 204 has a closed end wall 208, and a closed end wall 210. A storage chamber 212 is constructed within the center of the body portion 204. A contoured cover 216 is provided to close off an access opening 218 of the storage chamber 212. The cover 216 comprises a contoured outer plate 220, and a projecting slab 222. The projecting slab 222 is of the same shape as the access opening 218, and fits therein. The contoured plate 220 is constructed so as to be of the same shape, and fit within a recess within the wall of the body 204. As described above with respect to other embodiments of the invention, the cover 216 is secured to the body my means of bolts 224 and 226, passing through apertures 228 and 230, and engaging in threaded bores 232 and 234. The embodiment shown in FIG. 6 is therefore an alternative way of constructing a storage chamber into a generally cylindrical foot peg, and offers a variation in accessibility and shape of the storage space, as compared to the embodiment shown in FIG. 5 of the drawings.

The invention is not limited to the precise details described herein. Several variations can be made, including the shape and size of the storage compartment within the foot peg, the shape of the foot peg itself, and the nature of the covering piece to cover the access opening of the storage compartment, at the same time ensuring that, from external appearances, the foot peg resembles a conventional structure, to thereby provide a secure storage area for valuables.

It should also be understood that the storage lid, cover, cap or the like, may be hinged or somehow connected to the remaining body of the foot pedal, and may attach thereto using a lock and key mechanism, a snap-on arrangement, or any other manner. The overriding concern in all cases however would be to ensure that when the cover is attached to the body portion of the foot pedal, the combination of the two are structured and dimensioned so as to form a storage compartment which is to a large extent concealed and unnoticeable under normal or cursory examination or viewing of a foot pedal.

1. A foot peg for use on a motor cycle, the foot peg comprising:
a body portion having an outer surface of selected configuration, and having a storage compartment therein, the body portion having an access opening therein to provide access to the storage compartment through the outer surface;
a cover member for covering the access opening and thereby sealing it from outside of the foot peg, the cover member being movable between a closed position to close the access opening, and an open position to allow access to the storage compartment;
a connector portion formed on the body portion for connecting the foot peg to the motor cycle;
securing means for securing the cover member to the body portion;
the cover member being configured such that, when in the closed position, it is substantially continuous with the selected configuration of the outer surface of the body portion so as to substantially conceal from casual observation the existence of the storage compartment.

2. A foot peg as claimed in claim 1 wherein the body portion is generally cylindrical in shape.

3. A foot peg as claimed in claim 1 wherein the body portion is generally of rectangular shape.

4. A foot peg as claimed in claim 1 wherein the cover member comprises a contoured plate.

5. A foot peg as claimed in claim 4 wherein the cover member further comprises a projecting slab extending from the contoured plate, the projecting slab fitting within the access opening of the body portion, and the contoured plate covering the access opening.

6. A foot peg as claimed in claim 1 wherein the access opening is formed on an upper surface of the body portion.

7. A foot peg as claimed in claim 1 wherein the access opening is formed on a side surface of the body portion.

8. A foot peg as claimed in claim 2 wherein the cover portion comprises a screw-on cap.

9. A foot peg as claimed in claim 1 wherein the securing means comprises at least one bolt.

10. A foot peg as claimed in claim 1 wherein the securing means comprises correspondingly threaded portions of the body portion and the cover member respectively.

11. A foot peg as claimed in claim 1 wherein the securing means comprises a snap-on, mechanical connection.

12. A foot peg as claimed in claim 1 wherein the cover member comprises a rectangular plate having long sides and short sides, and flange members extending from the plate, being continuous with the rectangular member, the flange portions engaging the body portion.

13. A foot peg as claimed in claim 1 wherein at least a part of the body portion has formed thereon a non-slip or non-skid surface.

14. A foot peg as claimed in claim 12 wherein flanges extend from both the long and the short edges of the cover plate.

15. A foot peg as claimed in claim 1 wherein the securing means comprises a lock and key.

16. A foot peg as claimed in claim 9 wherein the bolt comprises a head having a hexagonal recess, and a key is provided for securing/fastening and unsecuring/unfastening the bolt.
